(19) United States
(12) Patent Application Publication
(10) Pub. No.: US 2007/0189652 A1
(43) Pub. Date: Aug. 16, 2007

(54) Pin-cage for a twin-row self-aligning roller bearing

(75) Inventors: Rainer Schroeder, Egenhausen (DE); Martin Grehn, Dittelbrunn (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, SCHWEINFURT (DE)

(21) Appl. No.: 10/593,159

(22) PCT Filed: Mar. 18, 2005
(86) PCT No.: PCT/DE05/00502

§ 371 Date: Sep. 15, 2006

(30) Foreign Application Priority Data
Mar. 19, 2004 (DE) 10 2004 013 542.8

(51) Int. Cl. F16C 33/52

(52) U.S. Cl. 384/574

(57) ABSTRACT

The invention relates to a pin-cage, for a twin-row self-aligning roller bearing, essentially comprising an inner ring, an outer ring and several rollers, running adjacently between the above, in two rows on the running tracks of the inner ring and the outer ring. A pin cage is arranged between the roller rows embodied with pins on the axial faces thereof at even spaces with a stepped offset. The rollers of both roller rows each comprise an axial through drilling, by means of which the above are rotatably mounted on the pins of the pin-cage. According to the invention, the pin-cage is embodied as a pre-assembled component without a lateral disc and pins feely extending axially from the above, the length of which is less than the length of the through drillings in the rollers, whereby lubrication of the rollers is achieved by centrifugal force from the free front face thereof through the outer opening of the through drilling thereof.

### FIELD OF THE INVENTION

The invention relates to a pin cage for a double-row self-aligning roller bearing, according to the features of patent claim 1 which form the preamble.

### BACKGROUND OF THE INVENTION

DE 28 363 99 A1 has disclosed a pin cage of the generic type for a double-row self-aligning roller bearing, which pin cage comprises substantially an inner bearing ring and an outer bearing ring and a plurality of rollers which run between them in two rows next to one another on their raceways. The pin cage is arranged between these two roller rows, which pin cage is configured on its axial sides with pins which are fastened offset to one another at uniform spacings and in a stepped manner, the rollers of both roller rows have one axial through hole each, via which they are each mounted rotatably on one pin of the pin cage. Here, in a concrete embodiment, the pin cage comprises a right-hand and a left-hand inner ring which are separated from one another by a space and are formed by one main ring each which is composed of two semicircular segments and one auxiliary ring each which is composed of two semicircular segments. At their one end, which is provided with a thread, the pins of the pin cage are each screwed into threaded holes of the respectively associated inner ring and at their other end are fastened in corresponding openings of a right-hand and left-hand, side disk which is arranged in each case between the inner and the outer bearing rings so as to bear against the outer end sides of the rollers. During assembly of the self-aligning roller bearing, this pin cage is mounted in such a way that first of all the semicircular segments of the main ring of one inner ring are arranged around the inner bearing ring which is pivoted out of the outer bearing ring, and then the semicircular segments of the auxiliary ring are positioned on the main ring with their abutment faces offset to the abutment faces of the main ring, and are preassembled on said main ring by auxiliary screws. Subsequently, the pins of one inner ring which each carry one roller are screwed into the threaded holes in the main ring, in order to connect the main ring and the auxiliary ring to one another further. After complete fastening of all pins to the inner ring, the other ends of the pins are introduced into the corresponding openings on the associated outer side disk and are connected fixedly to the latter with each one weld. Afterwards, the self-aligning roller bearing is turned by 1800 and the other inner ring of the pin cage is mounted in the same way.

However, it is a disadvantage of this known pin cage that it is, on the one hand, very expensive to manufacture as a result of its two-part configuration and the necessary large number of individual parts and, on the other hand, requires very complex and elaborate mounting of its individual segments and of the rollers, and therefore increases the manufacturing costs for a bearing which is configured with a pin cage of this type in a disadvantageous manner. Furthermore, the two outer side disks of the known pin cage have proven particularly disadvantageous to the extent, that they are arranged directly in front of the openings of the through holes of the rollers and therefore largely prevent an adequate lubricant supply to the bearing points of the rollers in the through holes. This can result in a lack of lubricant between the pins of the pin cage and the rollers, which leads to increased wear on the pin cage and/or on the rollers and ultimately has the consequence of a reduction in the service life of the bearing. In addition, this effect is reinforced by the fact that the outer side disks of the pin cage are welded to the ends of the pins, with the result that already during assembly of the bearing a large part of the lubricant in the through holes of the rollers is burnt by the high temperatures which occur during welding. Moreover, a further disadvantage of the two outer side disks of the known pin cage is that the axial installation dimension of the bearing must not be exceeded by them, with the result that the length of the rollers necessarily has to be reduced and the rollers cannot therefore roll on the entire possible width of the raceway of the outer bearing ring any more. Here, the reduction in the roller length has the consequence that the raceways on the inner and outer bearing rings have to be adapted to the changed geometry of the rollers in a complicated manner and the bearing overall has a reduced loadbearing capacity.

### OBJECT OF THE INVENTION

The invention is therefore based on the object of designing a pin cage for a double-row self-aligning roller bearing, which is of structurally simple configuration and which is distinguished by low manufacturing and mounting complexity and low manufacturing costs and which ensures sufficient lubrication of the bearing points of the rollers at all times and avoids the use of rollers with a reduced length.

### DESCRIPTION OF THE INVENTION

According to the invention, this object is achieved in a pin cage according to the preamble of claim 1, so that the pin cage is configured as a preassembled component without a side disk, which comprises a single-piece, closed annular disk and pins which protrude axially freely away from the latter and the length of which is smaller than the length of the through holes in the rollers. The lubrication of the rollers according to the invention takes place by centrifugal force from their free end side through the outer opening of their through hole, and at the same time the hollow space of these through holes, which is open as a result of the shortened pins, is configured as an additional lubricant reservoir.

In a functional development of the pin cage according to the invention, the annular disk of the pin cage preferably has a rhomboidal profile cross section, in which, based on a perpendicular axis of symmetry, the angles which lie opposite one another between the two upper side faces and the two lower side faces are cut off at right angles with respect to the axis of symmetry and therefore form a straight outer face and a parallel inner face on the annular disk.

A profile cross section of this type has proven particularly advantageous, as the lower side faces of the annular disk thus can, as a further feature of the pin cage according to the invention, be configured with perpendicularly inserted thoughholes for fastening the pins of the pin cage, whereas at the same time the angled arrangement of the lower side faces with respect to one another make it possible to produce the required axial inclination of the pins of the pin cage with respect to the raceways of the rollers on the inner and outer rings of the self-aligning roller bearing. Moreover, the lower side faces of the annular disk of the pin cage are, at the same time, provided as inner axial guide faces for the rollers of the self-aligning roller bearing, while the outer axial guidance of the rollers takes place by a known annular flange on the outer side of each raceway on the inner ring of the self-aligning roller bearing.

If, in conjunction with a pin cage according to the invention, the inner openings of the through holes in the rollers of the self-aligning roller bearing are each configured so as to be widened in the shape of a funnel by a radius, it is a further advantage of the rhomboidal profile cross section of the annular disk of the pin cage that its upper side faces, together with the radius of the through hole of each roller, each form a defined discharge channel for lubricant which emerges from the through holes. Since a conveying action of the lubricant along the pins through the through holes in the rollers is produced by the oblique position of the rollers and by the centrifugal force which acts on the lubricant during operation of the self-aligning roller bearing, the lubricant can therefore be discharged from an outer lubricant reservoir which is situated in a known manner between two outer grease catchment disks and the rollers or from the additional lubricant reservoir within the through holes of the roller via the consequently formed discharge channel into an inner lubricant reservoir which is formed above the annular disk of the pin cage, and can compensate at least partially for the amount of lubricant which is spent from this inner lubricant reservoir.

In a further embodiment of a pin cage according to the invention, the pins of the pin cage are preferably fastened by welding or screwing one of their ends in the holes on the lower side faces of the annular disk, welding of the pins having proven to be most inexpensive as a result of saving respective threads on the pins and in the holes of the annular disk. Further cost advantages can be obtained if the holes in the annular disk are omitted and the pins are welded flushly onto the lower side faces of the annular disk. In order to achieve sufficient stability despite the omission of the outer side disks on the pin cage, and at the same time an elasticity of the pin cage which is required for mounting of the rollers, shortened pins are used in the pin cage according to the invention, the free length of which remaining after being fastened to the annular disk corresponds to only approximately 50% to 70% of the length of the through holes in the rollers of the self-aligning roller bearing. The rollers are mounted on the pin cage, for example a pin cage which is guided by rollers, in such a way that the pin cage which is preassembled with the pins is introduced between the inner ring and the outer ring of the self-aligning roller bearing, and subsequently a first roller is placed with the inner opening of its through hole onto the free end of a pin. After this, the roller is pushed axially onto the pin by pressure on the roller in the direction of the annular disk, the radius at the inner opening of the through hole of the roller and the elasticity of the pin cage making it possible that the roll, which slides in the process with its circumferential surface over the annular flange on the raceway of the inner ring, can be pushed onto the pin in a tilted position until it latches into the raceway of the inner ring. Mounting of the remaining rollers of the first roller row takes place in the same way and, after the turning of the self-aligning roller bearing, also of the rollers of the second roller row.

Finally, it is a last feature of a pin cage according to the invention that its pins have, on their entire free length, a cylindrical profile cross section, their diameter being slightly smaller than the diameter of the through holes in the rollers. Rollers of this type can be manufactured simply and inexpensively and have optimum guiding properties for the rollers of the self-aligning roller bearing. Since offsets of the rollers or tilting of the rollers relative to the axes of the pins can occur during operation of the bearing due to the difference in diameter between the pins of the pin cage and the through holes of the rollers, the cylindrical profile cross section of the pins possibly leads to the situation where the rollers only have punctiform contact with the pins and the pins are therefore subjected to increased wear at these contact points. In order to avoid an effect of this type, it can therefore be advantageous to configure the pins, on their entire free length, on both sides of a transverse axis which corresponds to the longitudinal center of the rollers, with a conical profile cross section, with the result that the pins have their greatest diameter at the level of the longitudinal center of the rollers and then taper conically toward their ends. Thereby, in case of entanglement or tilting of the roller, achieving a continuous low-wear linear contact between the rollers and the pins, whereby the angle matching the average offset angle of the rollers of the self-aligning roller bearing that has proven to be sufficient is a cone angle of about 1° on both sides of the pin.

A pin cage according to the invention for a double-row self-aligning roller bearing therefore has the advantage, compared with the known pin cages from the prior art, that it is configured in a structurally simple manner as a closed annular disk with freely protruding pins and therefore comprises a minimum of individual parts which can be manufactured inexpensively. Furthermore, a pin cage according to the invention can be inserted as a preassembled component into the self-aligning roller bearing and makes simple and rapid mounting of the rollers on the pin cage possible, with the result that the manufacturing costs for a self-aligning roller bearing which is configured with a pin cage according to the invention are reduced to a minimum. Moreover, the omission of the two otherwise customary outer side disks on the pin cage ensures that sufficient lubricant can pass to the bearing points between the pins of the pin cage and the rollers at any time via the outer openings of the through holes in the rollers. Moreover, as a result of the absence of the two outer side disks, lubricant which has already been filled into the bearing can no longer be burnt by subsequent welding work on the cage during mounting of the bearing, so that, as a result of this and the additional lubricant reservoir which results from the shortened pins in the free hollow space of the through holes in the rollers, an increased lubricant stock is formed which contributes to a considerable increase in the service life of the self-aligning roller bearing. It is likewise possible, as a result of the omission of the two outer side disks, to use rollers for the self-aligning roller bearing which roll on the entire possible width of the raceways of the outer ring of the self-aligning roller bearing, with the result that the self-aligning roller bearings which are equipped with a pin cage according to the invention can be designed overall for higher loads.

### BRIEF DESCRIPTION OF THE DRAWINGS

One preferred embodiment of the pin cage according to the invention is explained in greater detail in the following text with reference to the appended drawings, in which:

FIG. 1 shows a three-dimensional illustration of a partially sectioned double-row self-aligning roller bearing having a pin cage according to the invention;

FIG. 2 shows an enlarged illustration of a cross section through a double-row self-aligning roller bearing having a pin cage according to the invention;

FIG. 3 shows a three-dimensional illustration of the pin cage according to the invention, as a preassembled component;

FIG. 4 shows an enlarged illustration of a cross section through the pin cage according to the invention; and

FIG. 5 shows an enlarged illustration of an alternative pin embodiment for the pin cage according to the invention.

### DETAILED DESCRIPTION OF THE DRAWINGS

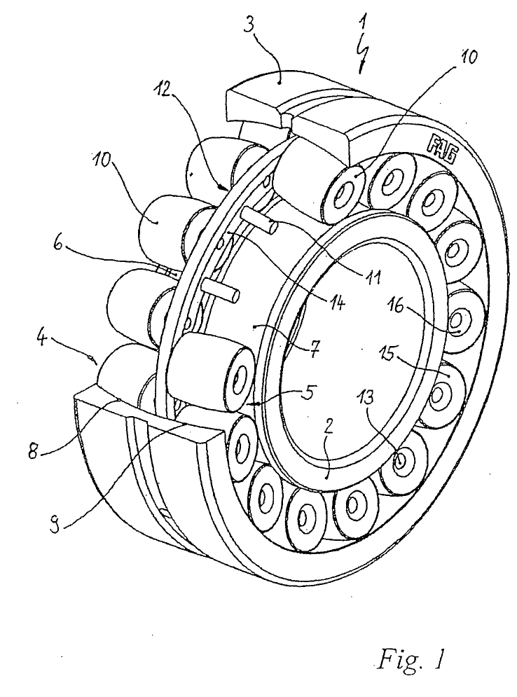

FIG. 1 clearly shows a double-row self-aligning roller bearing 1, which comprises substantially an inner ring 2 and an outer ring 3 and a plurality of rollers 10 which run between them in two rows 4, 5 next to one another on the raceways 6, 7, 8 and 9 of the inner ring 2 and the outer ring 3. A pin cage 12 which is configured on its axial sides with pins 11 which are fastened offset to one another at uniform spacings and in a stepped manner is clearly discernable between the two roller rows 4, 5, the rollers 10 of both roller rows 4, 5 each having one axial through hole 13, via which they each are mounted rotatably on one pin 11 of the pin cage 12.

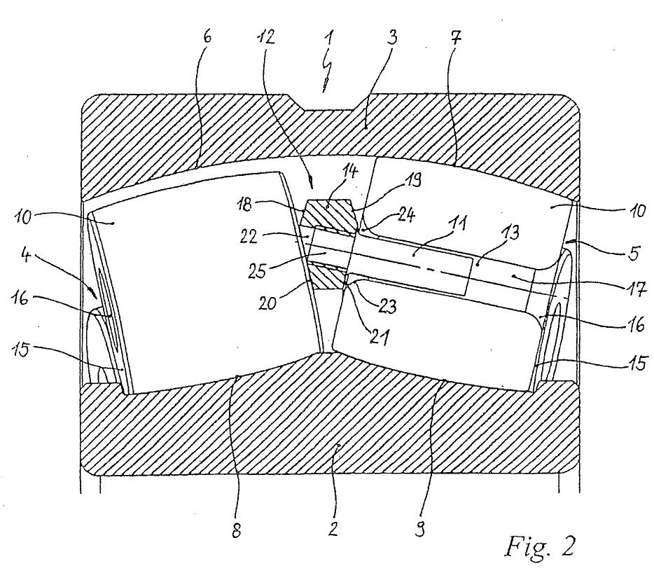

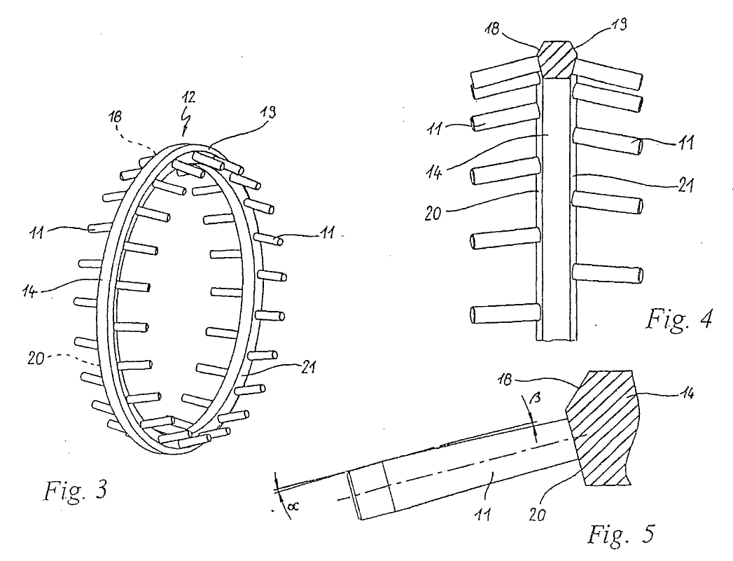

In FIGS. 2 and 3 it can be seen that the pin cage 12 according to the invention is configured as a preassembled component without outer side disks and comprises a single-piece, closed annular disk 14 and pins 11 which protrude axially freely away from the latter and the length of which is smaller than the length of the through holes 13 in the rollers 10. The lack of lubricant which occurs in known self-aligning roller bearings between the pins 11 and the rollers 10 is eliminated in this pin cage 12 by the fact that the lubrication of the rollers 10 takes place according to the invention from their free end side 15 from an outer lubricant reservoir which is not denoted in greater detail and is arranged between two grease catchment disks (not shown) and the rollers 10, through the outer opening 16 of their through holes 13, the free hollow space 17 of these through holes 13 which remains as a result of the shortened pins 11 of the pin cage 12 at the same time forming an additional lubricant reservoir.

Furthermore, it becomes clear as a result of the cross-sectional illustrations in FIGS. 2 and 4 that the annular disk 14 of the pin cage 12 has a rhomboidal profile cross section, in which, based on a perpendicular axis of symmetry, the angles which lie opposite one another between the two upper side faces 18, 19 and the two lower side faces 20, 21 are cut off at right angles with respect to the axis of symmetry and therefore form in each case one straight outer and inner face on the annular disk 14.

Into the lower side faces 20, 21 of the annular disk 14 of the pin cage 12, holes 22 are arranged perpendicularly with respect to said side faces 20, 21 which serve to fasten the pins 11 on the annular disk 14, the angular arrangement of the lower side faces 20, 21 with respect to one another producing at the same time the required axial inclination of the pins 11 of the pin cage 12 with respect to the raceways 6, 7, 8, 9 of the rollers 10 on the inner ring 2 and on the outer ring 3 of the self-aligning roller bearing 1. Moreover, the lower side faces 20, 21 of the annular disk 14 of the pin cage 12 are also provided as inner axial guide faces for the rollers 10 of the self-aligning roller bearing 1, while the outer axial guidance of the rollers 10 takes place by the annular flanges, which can be seen in FIG. 2 but are not denoted in greater detail, on the outer sides of the raceways 8, 9 on the inner ring 2 of the self-aligning roller bearing 1.

Moreover, it can be seen in FIG. 2 that the inner openings 23 of the through holes 13 in the rollers 10 of the self-aligning roller bearing 1 are configured so as to be widened in the manner of a funnel by a radius, with the result that the inner opening 23, together with the upper side faces 18, 19 of the annular disk 14 of the pin cage 12, forms a defined discharge channel 24 for lubricant which emerges from the through holes 13 of the rollers 10. As a result, the lubricant can be discharged from the above-mentioned outer lubricant reservoir of the self-aligning roller bearing 1 or from the additional lubricant reservoir in the free hollow space 17 of the through holes 13 of the rollers 10 via the discharge channel 24 which is consequently formed, in an unimpeded manner into an inner lubricant reservoir which is not denoted in greater detail above the annular disk 14 of the pin cage 12.

As is likewise shown in FIG. 2, the pins 11 of the pin cage 12 are then fastened by screwing one of their ends 25 in the holes 22 on the lower side faces 20, 21 of the annular disk 14, the ends 25 of the pins 11 and the holes 22 of the annular disk 14 being configured in each case with corresponding threads which are not denoted in greater detail. In order to give the pin cage 12 sufficient stability and at the same time the required elasticity for mounting of the rollers 10, the pins 11 are shortened in such a way that their free length which remains after fastening to the annular disk 14 corresponds to only approximately 50% to 70% of the length of the through holes 13 in the rollers 10 of the self-aligning roller bearing 1.

Finally, FIGS. 1 to 4 also show that the pins 11 of the pin cage 12 have, on their entire free length, a cylindrical profile cross section, their diameter being slightly smaller than the diameter of the through holes 13 in the rollers 10. In order, however, to preclude disadvantageous effects which occur in pins 11 having a profile cross section of this type in the event of tilting of the rollers 10 which occurs during operation of the self-aligning roller bearing 1, the pins 11 can also optionally be configured in the alternative shape which is shown in FIG. 5. In this embodiment, the pins 11 have a clearly visible conical profile cross section on their entire free length, on both sides of a transverse axis which corresponds to the longitudinal center of the rollers 10, with the result that the pins 11 have their greatest diameter at the level of the longitudinal center of the rollers 10 and then taper conically toward their ends. Such a profile cross section secures a continuous linear contact between rolls 10 and pins 11 in case of tilting of the rollers 10 during operation of the self-aligning roller bearing, whereas a cone angle α, β on both sides of the pins that corresponds to an average offset angle of the rollers 1 of the self-aligning roller bearing 1 has proven to be sufficient with about 1°.

### LIST OF DESIGNATIONS

1 Self-aligning roller bearing
2 Inner ring
3 Outer ring
4 Roller row
5 Roller row
6 Raceway
7 Raceway
8 Raceway
9 Raceway
10 Rollers
11 Pins
12 Pin cage
13 Through hole
14 Annular disk
15 End side
16 Outer opening
17 Hollow space
18 Upper side face
19 Upper side face
20 Lower side face
21 Lower side face
22 Hole
23 Inner opening
24 Discharge channel
25 Ends
α Cone angle
β Cone angle

1. A pin cage for a double-row self-aligning roller bearing, comprising:
a self-aligning roller bearing having an inner ring, an outer ring and a plurality of rollers which run between the inner ring and outer ring in two rows next to one another on raceways,
a pin cage arranged between the two rows of rollers the pin cage is configured, on its axial sides, with pins which are fastened offset to one another at uniform spacings and in a stepped manner,
each of the rollers having one axial through hole, via which each of the rollers are mounted rotatably on one pin of the pin cage,
wherein
the pin cage is configured as a preassembled component without a side disk, and comprises a single-piece, closed annular disk and pins which protrude axially freely away from the disk and the length of which is smaller than the length of the through holes in the rollers,
the lubrication of the rollers taking place by centrifugal force from their free end side through the outer opening of their through hole, and the free hollow space of these through holes being configured as an additional lubricant reservoir.

2. The pin cage of claim 1, wherein the annular disk of the pin cage has a rhomboidal profile cross section, having a perpendicular axis of symmetry, the angles which lie opposite one another between the two upper side faces and the two lower side faces are cut off at right angles with respect to the axis of symmetry.

3. The pin cage of claim 2, wherein the lower side faces of the annular disk of the pin cage preferably have perpendicularly inserted holes for fastening the pins, and are configured as inner axial guide faces of the rollers.

4. The pin cage of claim 2, wherein the inner openings of the through holes in the rollers of the self-aligning roller bearing are configured so as to be widened in each case by a radius and, together with the upper side faces of the annular disk of the pin cage form a defined discharge channel for lubricant which emerges from the through holes of the rollers.

5. The pin cage of claim 3, of the pins of the pin cage are fastened by welding or screwing one end in the holes on the lower side faces of the annular disk, and the free length of the pins corresponds to approximately 50% to 70% of the length of the through holes in the rollers.

6. The pin cage of claim 5, wherein the pins of the pin cage have, on their entire free length, either a cylindrical profile cross section or, on both sides of a transverse axis which corresponds to the longitudinal center of the rollers, a conical profile cross section, the cone angles (α, β) corresponding on both sides to the offset angle of the rollers of approximately 1°.
